(19) United States
(12) Patent Application Publication
(10) Pub. No.: US 2026/0064720 A1
(43) Pub. Date: Mar. 5, 2026

(54) METHOD AND SYSTEM FOR SELECTING DIVERSIFIED DATA FROM A DATASET

(71) Applicant: Honeywell International Inc., Charlotte, NC (US)

(72) Inventors: Ambarish Pathak, Mirzapur (IN); Benz Paulraj, Bangalore (IN)

(21) Appl. No.: 18/823,716

(22) Filed: Sep. 4, 2024

(51) Int. Cl. G06F 16/28

(52) U.S. Cl. CPC G06F 16/285

(57) ABSTRACT

The present disclosure relates to a method for selecting diversified data from a dataset. The method comprises determining numerical data and categorical data from the dataset and formulating a correlation between the numerical data and categorical data. A subset of data comprising uncorrelated numerical data and the categorical data is then prepared and allocated into one or more risk groups based on predefined risk factors, including at least one of geographical location, user identity, and number of identical transactions. Samples of data from a risk group of the one or more risk groups are chosen by first selecting an initial data point of the risk group and then iteratively selecting a subsequent data point of the risk group based on angular and euclidean distances of the initial data point from the subsequent data point of the risk group. A final dataset is generated and stored for training an AI model.

### TECHNICAL FIELD

The present disclosure generally relates to data analysis. In particular, the present disclosure relates to a method and system for analyzing large datasets using an optimal sampling approach.

### BACKGROUND

The rapid advancement of internet and smart mobile devices has led to an exponential increase in data across fields such as e-commerce, social networks, finance, medicine, and science. Extracting meaningful information from this vast amount of data and reducing large datasets to a few key samples has become increasingly important. Data Mining (DM) technology involves extracting knowledge from large, complex datasets using algorithms. Common methods include classification, regression, clustering, association rules, and feature extraction. Classification is a key method in data mining that involves learning from input data to create a model. This model helps in making informed judgments and classifying unknown data based on discovered rules. A key challenge in data mining and machine learning is addressing “imbalanced samples” in real-world data. Sample imbalance occurs when a dataset is dominated by one or more major classes with significantly more instances than the rare minority classes. In imbalanced data distribution, attention often focuses on rare categories, as they typically contain crucial information and have more severe misclassification consequences.

Imbalanced data distribution, also known as non-diversified data distribution, is a common issue in real-world scenarios such as credit card fraud detection, where the focus is on identifying rare fraudulent transactions. This is because misclassifying such transactions can result in significant economic losses. As datasets become higher in dimensionality, the problem of imbalanced data distribution becomes more complex, requiring effective feature selection techniques to improve classification accuracy. While traditional feature selection algorithms may struggle with high-dimensional imbalanced data, their importance is increasingly being recognized in addressing classification performance issues.

Many real-world scenarios demonstrate imbalanced data classification problems and challenges associated with large datasets, including network attack identification, customer churn prediction, earthquake prediction, risk management, and medical diagnosis. For instance, in credit card fraud detection, fraudulent activities are rare, involving only a few users. Companies must predict and prevent fraudulent transactions by illegal users, as misidentifying a fraudulent transaction as legitimate incurs greater costs than falsely labelling a legitimate transaction as fraudulent, leading to significant economic losses.

In particular, in order to identify whether the transactions comply with company rules or if any suspicious elements are involved in transactions with external customers/vendors, risk models are developed, and tags/labels are essential for training these models.

Compliance or audit experts are the right people to tag transaction as risky or non-risky. However, the time available to these experts is limited, and they cannot provide tags for a large number of transactions made in the company.

The growing volume of data in various industries presents both opportunities and challenges for data mining and machine learning. Addressing imbalanced or non-diversified samples in large datasets requires innovative approaches to feature selection and classification algorithms to improve accuracy and reliability in predictive modelling. By overcoming these challenges, businesses and organizations can unlock the full potential of big data and make informed decisions based on valuable insights extracted from complex data sources.

During data extraction, information is classified and stored in dominant categories such as name, place, date of birth, etc. However, some important features may be discarded or overshadowed by these dominant categories. This would eventually result in an imbalance final dataset, where one category becomes dominant over the other, causing important data to go undetected for further processing. This poses a serious problem in achieving a final dataset that is diverse and balanced, where important features are not overshadowed by dominant categories.

Addressing the above mentioned problem requires innovative approaches to feature selection and classification algorithms to improve accuracy and reliability in classification and sampling methodologies. At the present, there are no AI algorithms present in the industry that solves at least the above-mentioned problems. Thus, there is a major industrial need for developing supervised AI algorithms and sampling methodologies that are unique and reliable in analyzing large datasets.

### SUMMARY

The present disclosure provides a method and a system for selecting diversified data from a dataset.

In an embodiment of the present disclosure, a method of selecting diversified data from a dataset is provided. The method comprises determining numerical data and categorical data from the dataset and formulating a correlation between the numerical data and the categorical data. A subset of data is prepared which comprises uncorrelated numerical data and the categorical data. The subset of data is allocated into one or more risk groups based on predefined risk factors including at least one of geographical location, user identity, and number of identical transactions and a sample size is assigned to the one or more risk groups. The method further comprises choosing samples of data from a risk group of the one or more risk groups by selecting an initial data point of the risk group and iteratively selecting a subsequent data point of the risk group based on angular and euclidean distances of the initial data point from the subsequent data point of the risk group. A final dataset is generated which corresponds to the initial data point of the risk group and the subsequent data point of the risk group represents diversified variations with high coverage of both the numerical data and the categorical data. The final dataset is stored and used for training an AI model.

In some embodiments, a predetermined number of data from each risk group of the one or more risk groups is selected to maximize variability by arranging data from each risk group in descending order of their variance values, and the data is selected based on the descending order and the remaining data is discarded.

In some embodiments, the sample size is assigned to the one or more risk groups which can either be of an equal size sample or an unequal size sample.

In some embodiments, the unequal size sample means either a left skewed sample or a right skewed sample.

In some embodiments, samples of data are chosen from each risk group of the one or more risk groups by selecting an initial data point for each risk group and iteratively selecting a subsequent data point for each risk group based on the angular and euclidean distances of the initial data point from the subsequent data point for each risk group. A final dataset is generated for each risk group corresponding to the initial data point for each risk group and, the subsequent data point for each risk group represents diversified variations with high coverage of both the numerical and the categorical data.

In some embodiments, the subset of data further comprises a numerical data dominant dataset or a categorical data dominant dataset.

In some embodiments, scheming data with high entropy value comprises data with maximum variability in values.

In some embodiments, the predefined risk factors include factors essential for business transaction.

In yet another embodiment, a system to select diversified data from a data set is disclosed. The system includes a memory and a processor configured to determine numerical data and categorical data from the dataset and formulate a correlation between the numerical data and the categorical data. The processor is configured to prepare a subset of data which comprises uncorrelated numerical data and the categorical data. The subset of data is allocated into one or more risk groups based on predefined risk factors including at least one of geographical location, user identity, and number of identical transactions. A sample size is assigned to the one or more risk groups and samples of data is chosen from a risk group of the one or more risk groups by selecting an initial data point of the risk group and iteratively selecting a subsequent data point of the risk group based on angular and euclidean distances of the initial data point from the subsequent data point of the risk group. The processor is further configured to generate a final dataset corresponding to the initial data point of the risk group and the subsequent data point of the risk group representing diversified variations with high coverage of both the numerical data and the categorical data, and the final dataset is stored and used to train an AI model.

In another embodiment, a non-transitory computer-readable medium having stored thereon computer-readable instructions is disclosed. The computer-readable instructions, when executed by a processor, cause the processor to execute a method for selecting diversified data from a dataset by determining numerical data and categorical data from the dataset and formulating a correlation between the numerical data and the categorical data. A subset of data is prepared which comprises uncorrelated numerical data and the categorical data. The subset of data is allocated into one or more risk groups based on predefined risk factors including at least one of geographical location, user identity, and number of identical transactions and a sample size is assigned to the one or more risk groups. The method further comprises choosing samples of data from a risk group of the one or more risk groups by selecting an initial data point of the risk group and iteratively selecting a subsequent data point of the risk group based on angular and euclidean distances of the initial data point from the subsequent data point of the risk group. A final dataset is generated which corresponds to the initial data point of the risk group and the subsequent data point of the risk group represents diversified variations with high coverage of both the numerical data and the categorical data. The final dataset is stored and used for training an AI model.

The systems and methods of the present disclosure provides high variant/impactful samples with minimal sample size, thereby increasing productivity & utilization of business personnel's time effectively.

The systems and methods of the present disclosure also aids in the development of high accuracy AI model.

The systems and methods of the present disclosure additionally aid in capturing implicit requirements in an intuitive way through the minimal samples, which would take more time to do the requirement gathering process.

This summary is provided to describe select concepts in a simplified form that are further described in the detailed description. This summary is not intended to identify key or essential features of the claimed subject matter, nor is it intended to be used as an aid in determining the scope of the claimed subject matter.

These and other objectives and advantages of the present disclosure will become more apparent when reference is made to the following description.

### BRIEF DESCRIPTION OF THE DRAWINGS

To further clarify advantages and features of the present disclosure, a more particular description of the disclosure will be rendered by reference to specific embodiments thereof, which is illustrated in the appended drawings. It is appreciated that these drawings depict only typical embodiments of the disclosure and are therefore not to be considered limiting of its scope. The disclosure will be described and explained with additional specificity and detail with the accompanying drawings in which:

FIG. 1 illustrates a method of data classification according to an embodiment of the present disclosure;

FIG. 2 illustrates a flow chart showing a method for selecting diversified data from a dataset according to an embodiment of the present disclosure;

FIG. 3 represents a sample data from a sampling algorithm related to a transaction in two dimensions after applying PCA according to an embodiment of the present disclosure;

FIG. 4 represents a plot of existing sample data related to the transaction in two dimensions after applying PCA according to an embodiment of the present disclosure;

FIG. 5 represents a sample data from the sampling algorithm related to active customer relationship in two dimensions after applying PCA according to an embodiment of the present disclosure;

FIG. 6 represents existing sample data related to active customer relationship in 2 dimensions after applying PCA according to an embodiment of the present disclosure; and

FIG. 7 illustrates a schematic diagram of a communication apparatus according to an embodiment of the present disclosure.

Further, skilled artisans will appreciate that elements in the drawings are illustrated for simplicity and may not have necessarily been drawn to scale. For example, the flow charts illustrate the method in terms of the most prominent steps involved to help improve understanding of aspects of the present disclosure. Furthermore, in terms of the construction of the apparatus, one or more components of the apparatus may have been represented in the drawings by conventional symbols, and the drawings may show only those specific details that are pertinent to understanding the embodiments of the present disclosure so as not to obscure the drawings with details that will be readily apparent to those of ordinary skill in the art having the benefit of the description herein.

### DETAILED DESCRIPTION

The following description should be read with reference to the drawings, in which like elements in different drawings are numbered in like fashion. The drawings, which are not necessarily to scale, depict examples that are not intended to limit the scope of the disclosure. Although examples are illustrated for the various elements, those skilled in the art will recognize that many of the examples provided have suitable alternatives that may be utilized.

As used in this specification and the appended claims, the singular forms “a”, “an”, and “the” include the plural referents unless the content clearly dictates otherwise. As used in this specification and the appended claims, the term “or” is generally employed in its sense including “and/or” unless the content clearly dictates otherwise.

It is noted that references in the specification to “an embodiment”, “some embodiments”, “other embodiments”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is contemplated that the feature, structure, or characteristic may be applied to other embodiments whether or not explicitly described unless clearly stated to the contrary.

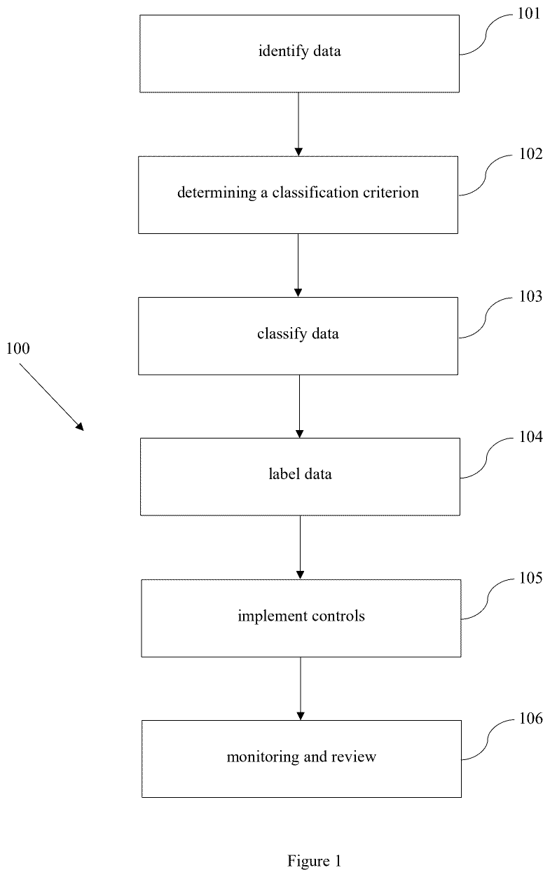

For the purpose of promoting an understanding of the principles of the disclosure, reference will now be made to the embodiment illustrated in the FIGS. 1 through 7 and specific language will be used to describe the same. It will nevertheless be understood that no limitation of the scope of the disclosure is thereby intended, such alterations and further modifications in the illustrated system, and such further applications of the principles of the disclosure as illustrated therein being contemplated as would normally occur to one skilled in the art to which the disclosure relates.

Embodiments of this disclosure provides high variant/impactful samples with minimal sample size, thereby increasing productivity & utilization of business personnel's time effectively. A system and method of the present disclosure aids in the development of high accuracy AI model. Additionally, the present disclosure aids in capturing implicit requirements in an intuitive way through the minimal samples, which would take more time to do the requirement gathering process.

The disclosed embodiments provide a solution to select diversified data from a dataset by analyzing large datasets using optimal sampling approaches. The present disclosure provides a solution by disclosing an intelligent mechanism which brings in key samples that are required to represent a whole dataset. The key samples are the most valuable samples that aids in the development of a high accuracy AI model. The solution described captures the samples with the most significant variations in the dataset, such that sending huge number of samples to the business personnel for tagging can be avoided.

To solve the problems highlighted in large datasets, data is classified in the large datasets which eventually results in balanced/diversified samples remaining in the reduced datasets by using suitable methods. Data classification is the process of organizing data into categories that make it easy to retrieve, sort, and store for future use. This process involves identifying the type, sensitivity, and value of data, which helps determine the best way to handle and protect it. Some of the key concepts and steps in data classification will be described hereinafter.

Data sensitivity determines the sensitivity of the data is and its potential impact if the same is disclosed, altered, or destroyed. Common sensitivity levels include: public data that can be freely shared with the public, internal data meant for internal use within an organization, confidential data that requires a high level of protection, and restricted data that requires the highest level of security.

FIG. 1 illustrates a method of data classification with the help of an example. The 1^{st} step involved in data classification is to identify data (step 101). This step describes to locate and identify all data within the organization. This includes structured data (like databases) and unstructured data (like emails and documents).

The 2^{nd} step is determining a classification criterion (step 102). This step describes to establish a criterion for classifying data based on sensitivity, regulatory requirements, and business value.

The 3^{rd} step is to classify data (step 103). This step describes to assign each data element to a category based on the established criteria. This can be done manually or through an automated tool.

The 4^{th} step is to label data (step 104). This step describes applying labels to the data indicating its classification. Labels can be physical (like tags on files) or digital (like metadata).

The 5^{th} step is to implement controls (step 105). Based on the classification, appropriate security controls need to be implemented and access restrictions are required to protect the data.

The 6^{th} step is about monitoring and review (step 106). The data is continuously monitored and the data classification is adjusted and controlled, as required. Regular reviews are conducted to ensure compliance with policies and regulations.

The classification of data results in several benefits such as improved data security, regulatory compliance, efficient data management, risk management, and enhanced decision-making. Also, the challenges involved in data classification are volume of data, changing regulations, user adoption and accuracy. Implementing a robust data classification strategy is essential for protecting sensitive information, ensuring compliance, and managing data efficiently within an organization. But how to reduce large datasets to make the data classification easier. The same shall be described in detail later in the disclosure.

Reducing large datasets typically involves techniques to simplify, summarize, or filter the data while retaining essential information. A common method to reduce large datasets is sampling. Sampling means selecting a representative subset of the data. Sampling generally is divided into two parts: random sampling and stratified sampling. In random sampling, samples are selected randomly from the dataset. Stratified sampling ensures that different segments of the dataset are proportionally represented.

The datasets can also be reduced by dimensionality reduction. Dimensionality reduction reduces the number of features while preserving important information. One of the most prevalent methods for dimensionality reduction is principal component analysis (PCA). PCA transforms data to a new coordinate system, reducing dimensions. Other important method is t-distributed stochastic neighbour embedding (t-SNE). This method reduces dimensions for visualization, especially in clustering tasks.

Feature selection is also used for reducing datasets. One of the well-known methods in feature selection is a filter method. This method uses statistical tests to select features. Other method is wrapper method which uses a predictive model to evaluate feature importance and lastly embedded method which selects features during the model training process.

As large-scale imbalanced/non-diversified data challenges grow, the complexity of data processing and classification increases, necessitating improved classification performance. The rise of big data along with improved data collection and storage has resulted in high-dimensional datasets with numerous features, exacerbating the class imbalance/non diversification problem. Feature selection is a key technique for reducing data dimensionality in high-dimensional data analysis. It enhances classification accuracy by selecting a subset of useful features based on specific criteria. While extensively studied in data mining and machine learning, its significance in addressing high-dimensional imbalanced data classification has gained more attention due to the impact of data imbalance on classification models.

A very basic technique to reduce large datasets is aggregation which means combining data points to create summaries. This can be done by calculating the mean of groups of the data points or by aggregating data by sum, count, max, min, etc.

Another important method is clustering which means grouping similar data points together and using cluster representatives. They are basically of two types. One is K-means clustering which describes partitioning data into clusters with a centroid. Other one is hierarchical clustering which means creating a tree of clusters. The most important is removing redundancies by eliminating duplicate or highly correlated data points.

One of the most important method for handling large imbalanced datasets is use of sampling algorithm to select a subset (sample) of data from a larger dataset. This is often done to make statistical inferences about the larger dataset to reduce computational costs, or to achieve other goals related to data analysis and processing. There are several types of sampling algorithms, each with its own strengths and use cases. Some of them are listed below.

Random sampling is one such technique where each element in the population has an equal probability of being selected. Another is stratified sampling in which the population is divided into strata, and random samples are taken from each stratum. Yet another one is systematic sampling where every k-th element in the population is selected after a random start.

Probabilistic sampling includes importance sampling where samples are drawn from a distribution that emphasizes important regions of the data space. Further, Metropolis-Hastings Algorithm is used a Markov Chain Monte Carlo (MCMC) method that samples from a probability distribution by building a Markov chain.

Non-probabilistic sampling convenience sampling takes samples from a group that is conveniently accessible.

In quota sampling, a population is segmented into mutually exclusive sub-groups, and samples are taken from each sub-group to meet a quota.

In sequential sampling, data is sampled in a sequential manner often used in quality control. Further, in adaptive sampling, the sampling strategy adapts based on information obtained during the sampling process, commonly used in ecological studies.

In case of reservoir sampling, an algorithm to randomly select k items from a list of n items, where n is either a very large or unknown number.

The application of these sampling methods are in quality control by checking a subset of products to infer the quality of the entire production batch and in machine learning where AI models are trained on subsets of data to reduce computational load and enhance performance.

The disclosure will now discuss the novel sampling method to reduce large datasets and imbalance in the data in these large datasets. The novel sampling method involves certain steps to output a reduced and diversified dataset.

The first step of the method is identification of significant features. The objective of the first step is to use a dataset by selecting important samples along with critical samples to generate a diversified dataset.

The most important samples (represented by letter ‘k’) are obtained from each category of data. There are two categories of data in the dataset namely, categorical data and numerical data. The categorical data includes any elements which is non-numeric in character. The most important samples from the numerical data are denoted by ‘k1’, and the important samples from categorical data are denoted by ‘k2’ and important samples (optional) from date feature types are denoted by ‘k3’. The same is represented in equation 1 below:

$$So , k = k 1 + k 2 + k 3 \qquad ( 1 )$$

The identification of important samples from each category are done as follows. Most important samples from the numerical data (k1) is selected from N number of features present in the dataset. This consists of following steps:

(1) Basis of numerical samples: The aim is to find an independent set of numerical samples from the set of all numerical samples F(n).

$$The basis B = \{ f : \vert corr ( f , x ) \vert < θ ∀ x ∈ F ( n ) - \{ f \} ∀ f ∈ F ( n ) \} \qquad ( 2 )$$

(2) The individual score for the numerical data is standard deviation on scaled feature data with min=0 and max=1.
Let f denote the sample values and scaled f be s(f) from B.

$$The importance score for f = s = ( \sum ( s ( f ) ( j ) - m ) 2 / ( n - 1 ) \qquad ( 3 )$$

Then for each sample f in the numerical data, the set of ordered importance scores are,

$$I = \{ s ( j ) , ∀ f ( j ) ∈ F ( n ) ) \} \qquad ( 4 )$$

And corresponding sample set in the same order be F, where s(j)>=s(j+1).

And let C be the set of cumulative sums of importance scores,

$$Then P = \{ c ( j ) / \sum s ( j ) ∀ c ( j ) ∈ C \} \qquad ( 5 )$$

For a given α,

$$H = \{ p ( j ) : p ( j - 1 ) - p ( j ) > α \} and c = \vert H \vert \qquad ( 6 )$$

And the optimal sample set,

$$opt ( F ( n ) ) = \{ f : f ( j ) ∈ ∀ j ∈ \{ 1 , 2 , … , c \} \} \qquad ( 7 )$$

Most important samples from the categorical data (k2) are selected from N number of features present in the dataset: The individual score for a categorical sample is based on entropy (e) of the sample.

$$e = - \sum p ( j ) * log \{ p ( j ) \} \qquad ( 8 )$$

and let d be the distinct counts of values in each categorical sample, then importance score of a sample is,

$$s = 1 / ( 1 + e \hat{} ( - 10 * ( e / d ) ) ) \qquad ( 9 )$$

Then for each sample f in the categorical dataset, the set of ordered importance scores are,

$$I = \{ s ( j ) , ∀ f ( j ) ∈ F ( c ) ) \} \qquad ( 10 )$$

And corresponding set in the same order be F, where s(j)>=s(j+1). And let C be the set of cumulative sums of importance scores,

$$Then P = \{ c ( j ) / \sum s ( j ) ∀ c ( j ) ∈ C \}$$

For a given α,

$$H = \{ p ( j ) : p ( j - 1 ) - p ( j ) > α \} and c = \vert H \vert \qquad ( 11 )$$

And the optimal dataset,

$$opt ( F ( n ) ) = \{ f : f ( j ) ∈ F ∀ j ∈ \{ 1 , 2 , … , c \} \} \qquad ( 12 )$$

The second step of the method is a risk bucket formation. After getting important set of samples from all the categories, the critical samples received from the business personnel is used to get the expected risk score of a given data point.

$$The risk score , ( r ) = \sum g ( j ) ( s ( j ) ) / k , \qquad ( 13 )$$

where g(j) is the jth risk function for s(j) feature and k is total number of critical samples received from the business personnel. Based on the risk score, the data point ‘d’ is classified in the risk bucket based on risk bucket range. For e.g., all the data points with the risk score between 0.7 to 0.8 will belong to the particular risk bucket of 0.7-0.8.

The third step of the method is determining sample sizes for each of the risk bucket. The sample sizes are computed for each of the risk buckets by dividing the total distinct risk buckets in the sample size. In case, a user wants to have unequal sample sizes from each risk class, the user can use a functionality within framework to generate the sample sizes with unequal distribution. By default, the sample sizes are equally distributed.

The fourth step of the method is choosing samples from the risk bucket. A numerical transformation on whole dataset for selected samples (critical samples provided by business personnel)+other critical samples (optional) is done for calculating the distances between each data point for each of the risk bucket. Let us assume for a given risk bucket data D (r) with transformed ‘c’ columns and ‘n’ rows, the initial sample set ‘S’ is empty in nature.

The objective function of the problem,

$$Argmax S ⊆ D ( r ) ( \sum A ( P ( j ) , p ( k ) ) + \sum L 2 ( p ( j ) , p ( k ) ) / 2 , \qquad ( 14 )$$

### Subject to,

$$P ( j ) , p ( k ) ∈ S ,$$

$$S ⊆ D ( r ) ,$$

$$j \neq k , ∀ j , k ∈ \{ 1 , 2 , … , \vert D ( r ) \vert \}$$

$$\sum A ( p ( j ) , p ( k ) ) > 0$$

$$\sum L 2 ( p ( j ) , p ( k ) ) > 0$$

The above objective function is an ideal to be maximized over a subset of the data and to obtain such subset, an approximation function to above objective function has been used.

The approximation function is as follows:

$$Argmax S ⊆ D ( r ) Fn ( x ) \qquad ( 15 )$$

$$Where Fn ( x ) = ( fn ∘ fn - 1 ∘ … ∘ f 0 )$$

$$And Fk ( x ) = \{ f 0 ( x ) : k = 0 \qquad ( 16 )$$

$$( fk ∘ Fk - 1 ) : k > 1$$

Where fn=A*(.): n is odd, and L2*(.): n is even. Also, ‘n’ is the sample size. Hence, the composition of functions takes place ‘n’ times alternatively. Where, A*(.) calculates angular distance between a point and a set of points and returns optimal set of points in the neighborhood of epsilon farthest away from the point. L2*(.) calculates euclidean distance between a point and a set of points and returns an optimal point which is approximately equidistant from the set of points which has already been identified as sample points. Then we can proceed further to get the optimal set S.

An initial random point p is chosen as a first sample point p1.

$$i . e . , p 1 ∈ S . \qquad ( 17 )$$

Selection of second point p2 from space D is based on following equation:
For a given eps ε1,

$$p 2 = \{ p : \vert A ( p 1 , p ) \vert ∈ [ max \{ A ( p 1 , p ( i ) ) \} - ε 1 , max \{ A ( p 1 , p ( i ) ) \} ] ∧ L 2 ( p 1 , p ) = max \{ L 2 ( p 1 , p ( i ) ) \} \qquad ( 18 )$$

$$Hence , S = \{ p 1 , p 2 \} \qquad ( 19 )$$

Choosing the next points from space follows from following equation,

(1) Selection of most angular diversified points from space D,
(a) We define r(j) for a point p(j) in space D-S,

$$r ( j ) = min \{ A ( p ( j ) , S ) \} / max \{ A ( p ( j ) , S ) \} \qquad ( 20 )$$

$$And R = \{ r ( j ) ∀ j ∈ ∧ ( D - S ) \}$$

$$And let r ( m ) = max R$$

$$( b ) A ( P ) = \{ p : r ( j ) ∈ [ r ( m ) - ε 1 , r ( m ) ] ∀ j ∈ ∧ ( D - S ) \} \qquad ( 21 )$$

(2) Selection of most L2 diversified points in space D-S,
(a) We define r(j) for a point p(j) in space A(P),

$$r ( j ) = min \{ L 2 ( p ( j ) , S ) \} / max \{ L 2 ( p ( j ) , S ) \} \qquad ( 22 )$$

$$And R = \{ r ( j ) ∀ j ∈ ∧ ( A ( P ) ) \}$$

$$And let r ( m ) = max R$$

(b) For a given delta δ1,

$$L ( P ) = \{ p : r ( j ) >= δ 1 , ∀ j ∈ ∧ ( A ( P ) ) \} \qquad ( 23 )$$

$$And let r ( m ) = max L ( P )$$

$${L}^{′} ( P ) = \{ p : r ( j ) ∈ [ r ( m ) - ε 1 , r ( m ) ] ∀ j ∈ ∧ ( L ( P ) ) \}$$

$$Argmax p ∈ L ( P ) f ( x ) = \{ p ∈ {L}^{′} ( P ) : f ( p ) = max y ∈ {L}^{′} ( P ) f ( y ) \}$$

$$Where f ( y ) = \sum ( L 2 ( p ( j ) , y )$$

(c) Addition of point p in sample set S,

$$S = S U \{ p \} \qquad ( 24 )$$

It has been seen that for the categorical data dominant dataset, the coverage for the numerical data is found less whereas the coverage for the categorical data is quite high, and for numerically dominant datasets, the coverage is high for both types of data. Here, ‘high coverage’ of any of the categorical data or the numerical data means coverage having more than 100 samples. However, in some embodiments, the ‘high coverage’ may also refer to coverage above a pre-determined threshold. Further, some important points to note are that if the coverage (joint) for the categorical data is low, the only solution is to increase the sample size. An ideal coverage for the categorical data and the numerical data is 100, so coverage closer to 100, better the samples are. If the coverage for the numerical data is close to 100 or above it (above in case of standard deviation stats used for coverage) (or 1 or >1), the samples are able to capture the sufficient variability of the numerical data. If the coverage for both the categorical data and the numerical data is too low (below 50%), it requires some modification in data or the feature sets or the sample size. Sometimes the algorithm returns lesser number of samples than asked for, because it saturates at some point, hence, to get the required number of samples, two parameters epsilon (81) and delta (81) need to be tuned. By increasing epsilon and decreasing delta, the sample size can be increased and vice versa. In case, the user does not want to send the equal number of samples from each risk bucket, other frequencies using a model may be used, which changes the distribution of sample sizes either from left or from right (left skewed and right skewed).

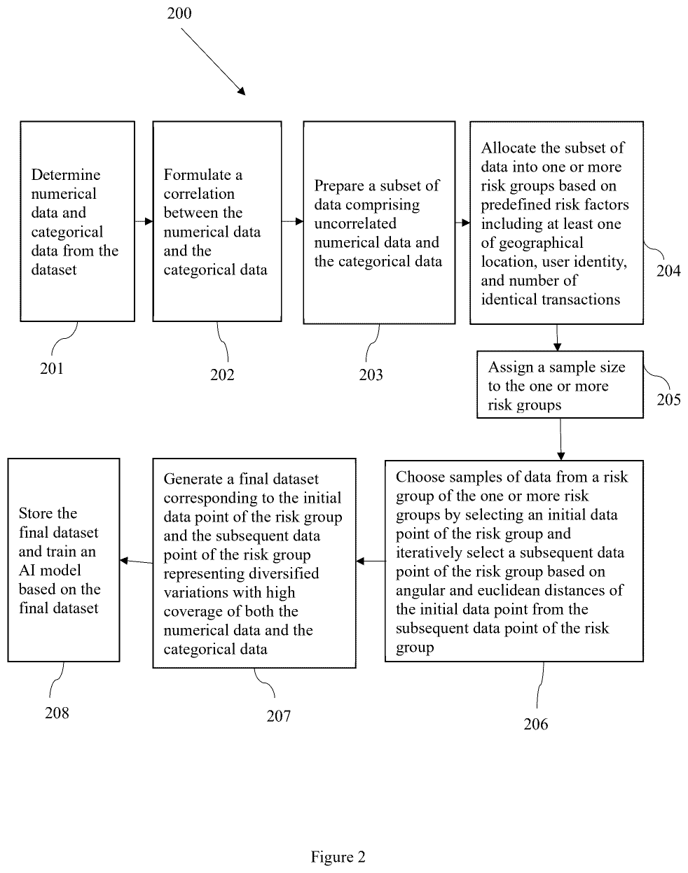

FIG. 2 illustrates a flow chart showing a method for selecting diversified data from a dataset in accordance with an embodiment of the disclosure. In step 201, the data in the dataset is classified into two categories. The two categories are the categorical data and the numerical data. The dataset used may be a structured dataset. In one of the preferred embodiments, the dataset contains samples related to transactions. The transaction data generally contain samples related to the numerical, the categorical and a date data type (optional). The data type does not play a significant role in obtaining a diversified dataset. The classified dataset, namely, the numerical data and the categorical data are further pruned to select only the samples with highest variability.

In step 202, with respect to the numerical data, the samples which explain the variability in the numerical data are chosen. For example, let us suppose there are fifty samples in the numerical data category. These fifty samples may be highly co-related to each other. It means they do not add any value and so, only one sample is more than enough to reflect these highly co-related fifty samples. This way the numerical data with large number of samples can be reduced by selecting only one sample and discarding the other with high correlation.

For pruning the categorical data, samples with high variability are selected. For each of the samples in the categorical data, entropy is calculated. The samples with higher entropy signify higher variability. This way the entropy is calculated for each of the samples to identify samples with higher variability. The threshold for higher variability can be set by the user.

Another important point to be noted is that the selected samples should not have too many unique values. After the above selection, the samples are arranged in descending order of their variance value along with the corresponding sample name. The samples in the descending order are further selected based on their overall importance in adding variability to the numerical data.

To understand the above, suppose there are hundred samples in the categorical data category. Out of these hundred samples, top seven samples are selected in order of their variance value. These seven samples may supposedly output a combined variance of 95% and adding eighth sample adds only 0.25% variance to bring the total 95.25%. This shows that only seven samples out of hundred samples are enough to bring a variance of 95%. The rest of the ninety-three samples can be discarded. In this way, samples in the categorical data are reduced.

Moving ahead, in step 203, a subset of the data is prepared which comprises an uncorrelated numerical data and the categorical data. In step 204, the subset of the data is allocated to one or more risk groups based on predefined risk factors including at least one of geographical location, user identity, and number of identical transactions.

The risk groups are prepared based on a risk score which is calculated using equation 13, listed above. The selected subset and samples therein are placed in the risk groups based on the risk score.

In step 205, a sample size is assigned to the one or more risk groups. Let us presume each risk group created in step 104 has thousand samples and from them fifteen samples are chosen. This number ‘fifteen’ is the sample size which means from each of the risk groups only fifteen samples are taken for further processing.

In step 206, samples of the data from the risk group is chosen by selecting an initial data point of the risk group and iteratively selecting a subsequent data point of the risk group based on maximum angular and euclidean distances of the initial data point to the subsequent data point of the risk group.

In particular, from one of the risk groups, the samples are taken to plot a 2-dimensional graph. These samples when plotted on the graph are known as data points. Firstly, a random data point is selected. After plotting the initial data point, a second data point is selected in such a way that it has maximum angular and euclidean distance from the initial data point.

The above step can be better understood by way of an example. Let us suppose that out of fifteen selected samples in step 106, one of the data points is randomly selected. This selected data point is known as the initial data point. From the remaining fourteen samples select the second/subsequent data point such that it has maximum angular and euclidean distance from the initial data point. This process is repeated for all the fifteen data points.

In step 207, the above described data points are plotted on a graph which are spread in a very diversified manner using the sampling algorithm describe above. In step 208, the final diverse dataset is used to train an AI model. The method described above in detail has been tested in real time by plotting the data to see diversified spread of the data points from the dataset. Analysis was done on the transaction data and on an active customer relationship data.

Independent Coverage Analysis: It considers the coverage at individual sample level and calculates average score.
a) Features provided by the business personnel of utmost importance: Amount_in_usd, payment_type, expense_type, missing_receipt
b) Other important features obtained from sampling algorithm: Report_total_in_usd, transaction_amount_in_reimbursable_currency, receipt_status, sbg, payment_key, back_office_comment, expense_sub_type, submit_date.
c) Following results were obtained while considering only features provided by business personnel (distinct count).
i. Coverage using algorithm: 0.88
ii. Coverage from existing samples: 0.75
iii. Relative coverage: 1.18
   Conclusion: Samples from algorithm>Existing samples and coverage is high around 88%.
d) Following results were obtained while considering numerical features (std).
i. Coverage using algorithm: 1.56
ii. Coverage from existing samples: 2.43
iii. Relative coverage: 0.64
   Conclusion: Samples from algorithm has less variability than other existing samples, though both the samples were able to capture high variance of the numerical data.
e) Following results were obtained while considering numerical features (range).
i. Coverage using algorithm: 0.15
ii. Coverage from existing samples: 0.23
iii. Relative coverage: 0.64
   Conclusion: Samples from algorithm and other existing samples both have less variability compared to data.
   Conclusion: The dataset is categorical feature dominant, hence algorithm gives higher priority to variance in the categories rather than variance in the numerical features, hence we can see that in presence of many categorical features, the algorithm sample coverage is high for the categorical features and low for the numerical features.
f) Following results were obtained while considering only features provided by business personnel.
i. Coverage using algorithm: 74.46
ii. Coverage from existing samples: 29.78
iii. Relative coverage: 2.07
g) Following results were obtained while considering only critical categorical features obtained from algorithm.
i. Coverage using algorithm 32.00
ii. Coverage from existing samples: 15.50
iii. Relative coverage: 1.93
h) Following results were obtained while considering only critical categorical features obtained from algorithm.
i. Coverage using algorithm: 10.03
ii. Coverage from existing samples: 4.97
iii. Relative coverage: 1.95
Conclusion: Samples from algorithm covers significant variability of whole data which is more than double of coverage from other existing samples. Hence, the samples from algorithm are able to capture more information from data when looked combined.

Analysis on sample 1 vs sample 2 with relative efficiencies has also been done. It measures the mean euclidean and mean angular distances between the samples and provides the relative measure of spread for the samples.
i. Following results were obtained for mean euclidean distance:
algorithm: 2.9
From existing samples: 2.29
Relative coverage: 1.26
j. Following results were obtained for mean Angular distance:
Algorithm: 0.598
From existing samples: 0.398
Relative coverage: 1.50
   Conclusion: Samples from algorithm are more diversified than existing samples. The net relative coverage is 1.76.

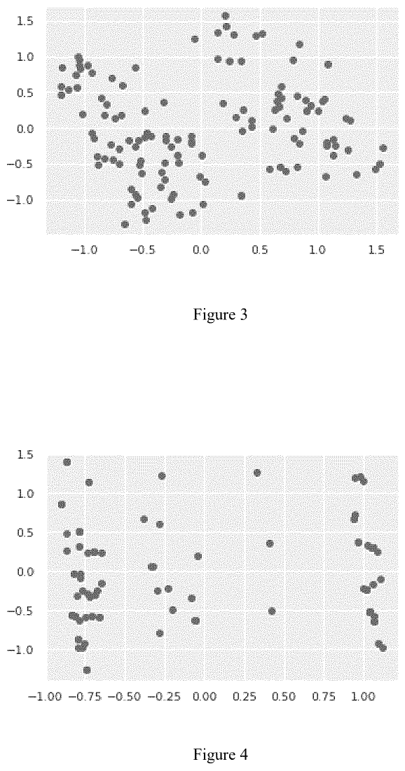

FIG. 3 represents sample data based on the sampling algorithm in two dimensions after applying PCA (principal component analysis) and FIG. 4 represents existing sample data in two dimensions after applying PCA.

Overall Conclusion: Referring to FIGS. 3 and 4, it can be seen that sampling algorithm generates very diversified points. Also, the sampling algorithm gives higher priority to the samples present in the categorical data rather than samples present in the numerical data.

Analysis on active customer relationship data samples has also been done.
k. Independent Coverage Analysis: It considers the coverage at individual feature level and calculates average score.
Used features provided by samples: num_of_trans, avg_days, avg_sales_amount
Other important features obtained from sampling algo: r (days_since_last_transaction/avg_days)
1. Following results were obtained while considering numerical features (std).
Coverage using algorithm: 1.11
Coverage from existing samples: 0.54
Relative coverage: 2.03
m) Following results were obtained while considering numerical features (range).
Coverage using algorithm: 0.78
Coverage from existing samples: 0.60
Relative coverage: 1.30
   Conclusion: Samples from algorithm has higher variability than other existing samples almost 1.3 times to double, resulting in high quality samples. Algorithm sample coverage is somewhere close to original data.

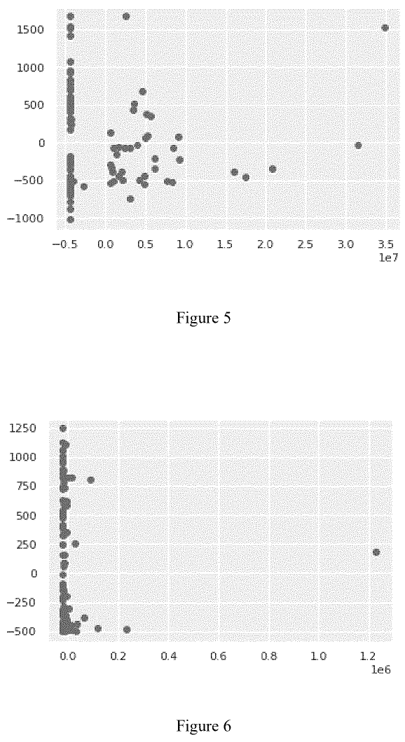

Analysis on sample 1 versus sample 2 with relative efficiencies has been done. It measures the mean euclidean and mean angular distances between samples and provides the relative measure of spread for the samples.
n. Following results were obtained for mean euclidean distance:
Algorithm: 0.83
From existing samples: 0.60
Relative coverage: 1.38
o. Following results were obtained for mean Angular distance:
Algorithm: 0.40
From existing samples: 0.27
Relative coverage: 1.48
   Conclusion: Samples from algorithm are more diversified than existing samples. The net relative coverage is 1.86.
   FIG. 5 represents sample data from sampling algorithm in 2 dimensions after applying PCA and FIG. 6 represents existing sample data in 2 dimensions after applying PCA.
   Overall Conclusion: As from the FIGS. 5 and 6, we can see that the sampling algorithm generates very diversified data points.

A use case scenario based on the novel sampling algorithm is described herein below.

In a Continuous Assessment Monitoring System (CAMS), fraudulent transactions are detected using an AI model. For the AI model to work, data is needed to train the AI model. The data used to train the AI model should have a high variance, for example, if we train the AI model to detect whether a flower is a rose or a lotus based on its properties, but during training, no data was provided regarding whether the flower is grown on land or on water surface. Therefore, if the AI model is used to classify flowers based on name and provide a surface value as water, the AI model would most likely predict the flower as any other lily-like flower similar to the lotus but not the lotus. That is why the AI model should be trained with different types of data.

Considering a specific scenario related to transactional travel allowance data (T and E data), in which an employee may conduct fraudulent transactions that violate a company's compliance policy. The transactional data contains more than millions of samples. Ideally, to train an AI model, each sample needs to be labeled. Out of all the samples, a few are selected to get labeled from some business personnel. If any other method is used to label the millions of transaction data, the end result will be that most of the samples in this dataset do not capture each and every transaction attributes, as was the case in the lotus example described in the above paragraph. Since very few samples are present in the current dataset which relates to fraudulent transaction, it becomes difficult to pick in initial few iterations of a labeling process that particular attribute/data which can lead to the fraudulent transaction i.e., a sufficient number of samples needs to be sent to the business personnel to capture such attributes. In the present case, few of the important attributes can be a) whether transactional receipts are available or not for any transaction; b) is the transaction been done with any government officials; c) if yes, what is an approval code, in which a country transaction has been made; d) is the transaction amount large or small; e) what is the transactions frequency of one employee with external vendors, etc. These are some of examples of the attributes associated with any transactional data.

Let us now consider the above use case scenario, mathematically. As described above, there are millions of samples related to the transactional data and a few of them have been sent for labelling to the business personnel, which includes many useless samples. It's imperative to understand that the business personnel do not have enough time to test each and every sample as the same is time consuming and the AI model will also take longer to get trained in appropriate way.

For example, each sample takes around half an hour on average for labelling, as the business personnel reviews the samples thoroughly. For e.g., if 100 samples are sent to the business personnel's initially, one business personnel will take around 50 hours for reviewing the samples. Since the business personnel are also involved with other related work, the labelling may take around two to three weeks.

Further, selecting samples with fraudulent transactional attributes and sending them for labelling is quite tricky. Even if samples with all the combinations of attributes are picked which may indicate a fraud transaction, it is very hard to locate them.

Normally, a dataset does not contain even 3% of transactions which are risky, but the AI model should be able to use such data to predict the output in a consistent manner. Considering again the case where 100 samples were sent to the business personnel, not more than 5 samples may be risky, as there are less than 3% chance of risky fraudulent transactions. Therefore, the AI model post labelling has around 97 to 98 samples related with normal transaction and only 2 to 3 samples related to fraudulent transactions. In these 2 to 3 fraudulent transaction samples, all possible combinations of transactional attributes which are truly the cause of the fraud transactions will not be seen by the business personnel and due to this issue, the AI model also would not be able to learn (similar to lotus example).

If the same methodology is used for selecting the samples and sending them to the business personnel, it will take a long time to figure out all possible combinations of transactional attributes associated to fraud. Also, in the present dataset, which contains so many such combinations (as per mentioned attributes of transactions, country, receipt availability . . . ), there are going to be 64 risky patterns and to capture it all, 3200 transactional records need to be sent for labelling, which is a huge time consuming task for the business personnel.

With the present novel sampling algorithm, there is no need to send huge number of samples, since the sampling algorithm works in unique way to find the most dissimilar samples.

Referring again to FIGS. 3 and 4, the diversity of the transactional data in two dimensions using PCA has been depicted. FIG. 3 represents a sample data from the sampling algorithm which generates well balanced diversified samples as compared to FIG. 4 which is using the mix of stratified+random sampling method.

On careful observation of FIGS. 3 and 4, it is evident that the samples are well diversifying in FIG. 3 where x-axis ranges from −1 to 1.5, which is 1.5 times the range of FIG. 4 x-axis range.

The novel sampling algorithm efficiently saves time and accelerates the AI model development by obtaining labels from business personnel, enabling quick learning, and efficient model building.

In yet another embodiment, a system to select diversified data from a data set is disclosed. The system includes a memory and a processor configured to determine numerical data and categorical data from the dataset and formulate a correlation between the numerical data and the categorical data. The processor is configured to prepare a subset of data which comprises uncorrelated numerical data and the categorical data. The subset of data is allocated into one or more risk groups based on predefined risk factors including at least one of geographical location, user identity, and number of identical transactions. A sample size is assigned to the one or more risk groups and samples of data is chosen from a risk group of the one or more risk groups by selecting an initial data point of the risk group and iteratively selecting a subsequent data point of the risk group based on angular and euclidean distances of the initial data point from the subsequent data point of the risk group. The processor is further configured to generate a final dataset corresponding to the initial data point of the risk group and the subsequent data point of the risk group representing diversified variations with high coverage of both the numerical data and the categorical data, and the final dataset is used to train an AI model.

In another embodiment, a non-transitory computer-readable medium having stored thereon computer-readable instructions is disclosed. The computer-readable instructions, when executed by a processor, cause the processor to execute a method for selecting diversified data from a dataset by determining numerical data and categorical data from the dataset and formulating a correlation between the numerical data and the categorical data. A subset of data is prepared which comprises uncorrelated numerical data and the categorical data. The subset of data is allocated into one or more risk groups based on predefined risk factors including at least one of geographical location, user identity, and number of identical transactions and a sample size is assigned to the one or more risk groups. The method further comprises choosing samples of data from a risk group of the one or more risk groups by selecting an initial data point of the risk group and iteratively selecting a subsequent data point of the risk group based on angular and euclidean distances of the initial data point from the subsequent data point of the risk group. A final dataset is generated which corresponds to the initial data point of the risk group and the subsequent data point of the risk group represents diversified variations with high coverage of both the numerical data and the categorical data. The final dataset is stored and used for training an AI model.

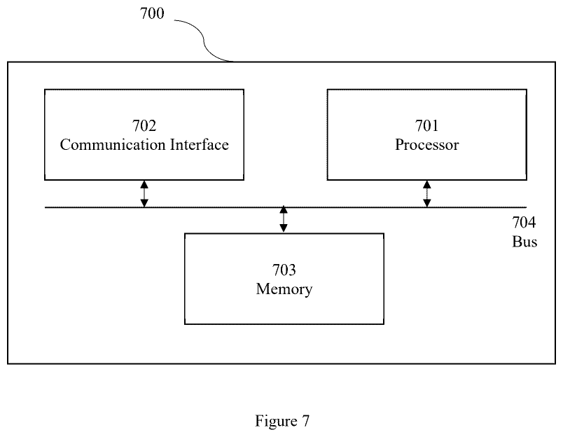

FIG. 7 illustrates a schematic diagram of another communication apparatus 700 according to an embodiment of the disclosure. The communication apparatus 700 includes a processor 701, a communication interface 702, and a memory 703. The processor 401, the communication interface 702, and the memory 703 may be connected to each other via a bus 704. The bus 704 may be a peripheral component interconnect (peripheral component interconnect, PCI) bus, an extended industry standard architecture (extended industry standard architecture, EISA) bus, or the like. The bus 704 may be classified into an address bus, a data bus, a control bus, and the like. For ease of representation, the bus is represented by using only one line in FIG. 7, but it does not indicate that there is only one bus or one type of bus. The processor 701 may be a central processing unit (central processing unit, CPU), a network processor (network processor, NP), or a combination of a CPU and an NP. The processor may further include a hardware chip. The hardware chip may be an application-specific integrated circuit (application-specific integrated circuit, ASIC), a programmable logic device (programmable logic device, PLD), or a combination thereof. The PLD may be a complex programmable logic device (complex programmable logic device, CPLD), a field-programmable gate array (field-programmable gate array, FPGA), generic array logic (Generic Array Logic, GAL), or any combination thereof. The memory 403 may be a volatile memory or a non-volatile memory, or may include a volatile memory and a non-volatile memory. The non-volatile memory may be a read-only memory (read-only memory, ROM), a programmable read-only memory (programmable ROM, PROM), an erasable programmable read-only memory (erasable PROM, EPROM), an electrically erasable programmable read-only memory (electrically EPROM, EEPROM), or a flash memory. The volatile memory may be a random access memory (random access memory, RAM), and is used as an external cache.

The connecting lines shown in the various figures contained herein are intended to represent exemplary functional relationships and/or physical couplings between the various elements. It should be noted that many alternative or additional functional relationships or physical connections may be present in an embodiment of the subject matter.

The subject matter may be described herein in terms of functional and/or logical block components, and with reference to symbolic representations of operations, processing tasks, and functions that may be performed by various computing components or products. It should be appreciated that the various block components shown in the figures may be realized by any number of hardware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control products. Furthermore, embodiments of the subject matter described herein can be stored on, encoded on, or otherwise embodied by any suitable non-transitory computer-readable medium as computer-executable instructions or data stored thereon that, when executed (e.g., by a processing system), facilitate the processes described above.

Usually, various embodiments of this disclosure may be implemented by hardware or a dedicated circuit, software, logic, or any combination thereof. Some aspects may be implemented by the hardware, and other aspects may be implemented by firmware or software, and may be performed by a controller, a microprocessor, or another computing device. Although aspects of embodiments of this disclosure are shown and described as block diagrams, flowcharts, or some other figures, it should be understood that the blocks, apparatuses, systems, technologies, or methods described in this specification may be implemented as, for example, non-limiting examples, hardware, software, firmware, dedicated circuits or logic, general-purpose hardware or controllers or other computing devices, or a combination thereof.

This disclosure further provides at least one computer program product tangibly stored on a non-transitory computer-readable storage medium. The computer program product includes computer-executable instructions, such as instructions included in a program module, which are executed in a device on a real or virtual processor of a target, to perform the processes/methods described above with reference to the accompanying drawings. Usually, a program module includes a routine, a program, a library, an object, a class, a component, a data structure, or the like that performs a particular task or implements a particular abstract data type. In various embodiments, functions of the program module may be combined or a function of the program module may be as needed. Machine-executable instructions for the program module may be executed locally or within a distributed device. In the distributed device, the program module may be located in local and remote storage media.

Computer program code for implementing the method disclosed in this disclosure may be written in one or more programming languages. The computer program code may be provided for a processor of a general-purpose computer, a dedicated computer, or another programmable data processing apparatus, so that when the program code is executed by the computer or the another programmable data processing apparatus, a function/operation specified in the flowchart and/or the block diagram is implemented. The program code may be completely executed on a computer, partially executed on a computer, independently performed as a software package, partially executed on a computer and partially executed on a remote computer, or completely executed on a remote computer or a server.

In context of this disclosure, the computer program code or related data may be borne in any appropriate carrier, so that the device, the apparatus, or the processor can perform various processing and operations described above. An example of the carrier includes a signal, a computer-readable medium, and the like. An example of the signal may include propagating signals in electrical, optical, radio, sound, or other forms, such as carrier waves and infrared signals.

The computer-readable medium may be any tangible medium that includes or stores a program used for or related to an instruction execution system, apparatus, or device. The computer-readable medium may be a computer-readable signal medium or a computer-readable storage medium. The computer-readable medium may include but is not limited to an electronic, magnetic, optical, electromagnetic, infrared, or semiconductor system, apparatus, or device, or any suitable combination thereof. A more detailed example of the computer-readable storage medium includes an electrical connection with one or more wires, a portable computer disk, a hard disk, a random access memory (RAM), a read-only memory (ROM), an erasable programmable read-only memory (EPROM or flash memory), an optical storage device, a magnetic storage device, or any suitable combination thereof.

The foregoing description refers to elements or nodes or features being “coupled” together. As used herein, unless expressly stated otherwise, “coupled” means that one element/node/feature is directly or indirectly joined to (or directly or indirectly communicates with) another element/node/feature, and not necessarily mechanically. Thus, although the drawings may depict one exemplary arrangement of elements directly connected to one another, additional intervening elements, products, features, or components may be present in an embodiment of the depicted subject matter. In addition, certain terminology may also be used herein for the purpose of reference only, and thus are not intended to be limiting.

It may further be advantageous to set forth definitions of certain words and phrases used throughout this patent document. The terms “transmit,” “receive,” and “communicate,” as well as derivatives thereof, encompasses both direct and indirect communication. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, Band C, and A and Band C.

The foregoing detailed description is merely exemplary in nature and is not intended to limit the subject matter of the application and uses thereof. Furthermore, there is no intention to be bound by any theory presented in the preceding background, brief summary, or the detailed description.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the subject matter in any way. Rather, the foregoing detailed description will provide those skilled in the art with a convenient road map for implementing an exemplary embodiment of the subject matter. It should be understood that various changes may be made in the function and arrangement of elements described in an exemplary embodiment without departing from the scope of the subject matter as set forth in the appended claims. Accordingly, details of the exemplary embodiments or other limitations described above should not be read into the claims absent a clear intention to the contrary.

1. A computer-implemented method for selecting diversified data from a dataset, executing, by a processor, operations comprising:
determining numerical data and categorical data from the dataset, wherein the numerical data and the categorical data are continuously monitored and adjusted to ensure compliance with policies and regulations;
identifying, by the processor, a subset of uncorrelated numerical data based on correlations within the numerical data;
removing, by the processor, the numerical data that exceed a predefined correlation threshold;
prioritizing, by the processor, the remaining numerical data based on a variability score for each numerical data feature;
computing, by the processor, an importance score for each of categorical data feature from one or more categorical data features based on an entropy;
arranging, by the processor, the one or more categorical data features based on a respective importance score;
selecting a subset of high-importance categorical data features from the arranged one or more categorical data features;
formulating, by the processor, a correlation between the selected numerical data and the categorical data feature;
preparing, by the processor, a subset of data comprising the uncorrelated numerical data and the categorical data;
allocating, by the processor, the subset of data into one or more risk groups based on predefined risk factors including at least one of geographical location, user identity, and number of identical transactions;
assigning, by the processor, a sample size to the one or more risk groups;
choosing samples of data from a risk group of the one or more risk groups by selecting an initial data point of the risk group and iteratively selecting a subsequent data point of the risk group based on angular and Euclidean distances of the initial data point from the subsequent data point of the risk group;
generating, by the processor, a final dataset corresponding to the initial data point of the risk group and the subsequent data point of the risk group representing diversified variations with high coverage of both the numerical data and the categorical data; and
storing, by the processor, the final dataset to train an AI model for detecting deviations in the dataset.

2. The method as claimed in claim 1, further comprising:
selecting a predetermined number of data from each risk group of the one or more risk groups to maximize variability by arranging data from each risk group in descending order of their variance values; and
selecting the data based on the descending order and discarding the remaining data.

3. The method as claimed in claim 1, wherein assigning the sample size to the one or more risk groups can either be of an equal size sample or an unequal size sample.

4. The method as claimed in claim 3, wherein the unequal size sample means either a left skewed sample or a right skewed sample.

5. The method as claimed in claim 1, further comprising:
choosing samples of data from each risk group of the one or more risk groups by selecting an initial data point for each risk group and iteratively selecting a subsequent data point for each risk group based on the angular and Euclidean distances of the initial data point from the subsequent data point for each risk group; and
generating a final dataset for each risk group corresponding to the initial data point for each risk group and the subsequent data point for each risk group representing diversified variations with high coverage of both the numerical and the categorical data, wherein a risk score is computed for each of the initial data point based on plurality of features, wherein each feature from the plurality of features is determined by an expert and is associated with at least one predefined risk factor, wherein the risk score associated with the plurality of features is configured to quantify contribution to risk assessment based on predefined criteria.

6. The method as claimed in claim 1, wherein preparing the subset of data further comprises a numerical data dominant dataset or a categorical data dominant dataset.

7. The method as claimed in claim 1, further comprising scheming data with high entropy value comprises data with maximum variability in values.

8. The method as claimed in claim 1, wherein the predefined risk factors include factors essential for business transaction.

9. A system, comprising:
a memory; and
a processor configured to:
determine numerical data and categorical data from the dataset, wherein the numerical data and the categorical data are continuously monitored and adjusted to ensure compliance with policies and regulations;
identify, by the processor, a subset of uncorrelated numerical data based on correlations within the numerical data;
remove, by the processor, the numerical data that exceed a predefined correlation threshold:
prioritize, by the processor, the remaining numerical data based on a variability score for each numerical data feature;
compute, by the processor, an importance score for each of categorical data feature from one or more categorical data features based on an entropy;
arrange, by the processor, the one or more categorical data features based on a respective importance score;
select a subset of high-importance categorical data features from the arranged one or more categorical data features;
formulate a correlation between the selected numerical data and the categorical data feature;
prepare a subset of data comprising the uncorrelated numerical data and the categorical data;
allocate the subset of data into one or more risk groups based on predefined risk factors including at least one of geographical location, user identity, and number of identical transactions;
assign a sample size to the one or more risk groups;
choose samples of data from a risk group of the one or more risk groups by selecting an initial data point of the risk group and iteratively selecting a subsequent data point of the risk group based on angular and Euclidean distances of the initial data point from the subsequent data point of the risk group;
generate a final dataset corresponding to the initial data point of the risk group and the subsequent data point of the risk group representing diversified variations with high coverage of both the numerical data and the categorical data; and
store the final dataset to train an AI model for detecting deviations in the dataset.

10. The system as claimed in claim 9, wherein the processor further configured to:
select a predetermined number of data from each risk group of the one or more risk groups to maximize variability by arranging data from each risk group in descending order of their variance values; and
select the data based on the descending order and discard the remaining data.

11. The system as claimed in claim 9, wherein assigning the sample size to the one or more risk groups can either be of an equal size sample or an unequal size sample.

12. The system as claimed in claim 11, wherein the unequal size sample means either a left skewed sample or a right skewed sample.

13. The system as claimed in claim 9, wherein the processor further configured to:
choose samples of data from each risk group of the one or more risk groups by selecting an initial data point for each risk group and iteratively selecting a subsequent data point for each risk group based on the angular and Euclidean distances of the initial data point from the subsequent data point for each risk group; and
generate a final dataset for each risk group corresponding to the initial data point for each risk group and the subsequent data point for each risk group representing diversified variations with high coverage of both the numerical and the categorical data, wherein a risk score is computed for each of the initial data point based on plurality of features, wherein each feature from the plurality of features is determined by an expert and is associated with at least one predefined risk factor, wherein the risk score associated with the plurality of features is configured to quantify contribution to risk assessment based on predefined criteria.

14. The system as claimed in claim 9, wherein preparing the subset of data further comprises a numerical data dominant dataset or a categorical data dominant dataset.

15. The system as claimed in claim 9, wherein the processor further configured to scheme data with high entropy value comprises data with maximum variability in values.

16. The system as claimed in claim 9, wherein the predefined risk factors include factors essential for business transaction.

17. A non-transitory computer-readable medium having stored thereon computer-readable instructions that, when executed by a processor, cause the processor to execute a method for selecting diversified data from a dataset, comprising:
determining numerical data and categorical data from the dataset, wherein the numerical data and the categorical data are continuously monitored and adjusted to ensure compliance with policies and regulations;
identifying, by the processor, a subset of uncorrelated numerical data based on correlations within the numerical data;
removing, by the processor, the numerical data that exceed a predefined correlation threshold;
prioritizing, by the processor, the remaining numerical data based on a variability score for each numerical data feature;
computing, by the processor, an importance score for each of categorical data feature from one or more categorical data features based on an entropy;
arranging, by the processor, the one or more categorical data features based on a respective importance score;
selecting a subset of high-importance categorical data features from the arranged one or more categorical data features;
formulating a correlation between the selected numerical data and the categorical data feature;
preparing a subset of data comprising the uncorrelated numerical data and the categorical data;
allocating the subset of data into one or more risk groups based on predefined risk factors including at least one of geographical location, user identity, and number of identical transactions;
assigning a sample size to the one or more risk groups;
choosing samples of data from a risk group of the one or more risk groups by selecting an initial data point of the risk group and iteratively selecting a subsequent data point of the risk group based on angular and Euclidean distances of the initial data point from the subsequent data point of the risk group;
generating a final dataset corresponding to the initial data point of the risk group and the subsequent data point of the risk group representing diversified variations with high coverage of both the numerical data and the categorical data;
storing the final dataset to train an AI model for detecting deviations in the dataset.

18. The computer-readable medium as claimed in claim 17, wherein computer-readable instructions, when executed by the processor, causes the processor to:
select a predetermined number of data from each risk group of the one or more risk groups to maximize variability by arranging data from each risk group in descending order of their variance values; and
select the data based on the descending order and discard the remaining data.

19. The computer-readable medium as claimed in claim 17, wherein computer-readable instructions, when executed by the processor, causes the processor to scheme data with high entropy value comprises data with maximum variability in values.

20. The computer-readable medium as claimed in claim 17, wherein computer-readable instructions, when executed by the processor, causes the processor to prepare the subset of data comprising a numerical data dominant dataset or a categorical data dominant dataset.
